(19) United States
(12) Patent Application Publication
(10) Pub. No.: US 2025/0054021 A1
(43) Pub. Date: Feb. 13, 2025

(54) CAMPAIGN FEEDBACK BASED INCREMENTAL HYBRID AUDIENCE SUGGESTION AI ENGINE

(71) Applicant: LiveIntent, Inc., New York, NY (US)

(72) Inventors: Patrick Gadd, Virum (DK); Niels Boldt, Brønshøj (DK); Mano Pillai, Chantilly, VA (US); Deepthi Venkitaramanan, Bolingbrook, IL (US)

(21) Appl. No.: 18/766,547

(22) Filed: Jul. 8, 2024

Related U.S. Application Data
(60) Provisional application No. 63/525,707, filed on Jul. 9, 2023.

(51) Int. Cl. G06Q 30/0242; G06Q 30/0251

(52) U.S. Cl. CPC G06Q 30/0244; G06Q 30/0251

(57) ABSTRACT

The inventions disclosed herein relate to the audience discovery process through smart nudging methodology, and preferably include a campaign feedback based incremental hybrid audience suggestion AI engine, including an interface via which a user can input one or more goals, progenerating a set of audiences, selecting at least one progenerated set of audiences, and allowing a user to launch a campaign.

### BACKGROUND OF THE INVENTION

### Field of Invention

The inventions disclosed herein generally relate to the audience discovery process through smart nudging methodology. Data may be collected from websites through tags, click logs, email extensions, identity graphs, and other sources.

### BRIEF DESCRIPTION OF THE DRAWINGS

FIG. 1 illustrates an exemplary interface related to acquiring new customers.

FIG. 2 illustrates an exemplary interface related to selecting an audience type.

FIG. 3 illustrates exemplary potential system elements.

### DETAILED DESCRIPTION OF EMBODIMENTS OF THE INVENTION

Through information we know about advertiser on prior campaigns run with us, data collected from their website through live connect tags and/or other tags, email service provider click logs, liveconnect email extension, and identity graph attributes, offline graph attributes and propensity of individual hashes to engage with specific advertisers, we create personalized audiences for advertisers through a variety of models such as contextual audiences, lookalike audiences, live audiences, interest based audiences, site visitor segments etc. The audiences tailored for these advertisers are readily available for them in the UI.

Some of the audiences may not be generated here for the advertiser because they are not using the necessary products from us for creating this audience. In those cases, we may either show the audience count as zero or gray out audiences to inform them of the product they need to use to be able to generate the specific audience. This preferably happens automatically based on the data we have for the advertiser in the backend.

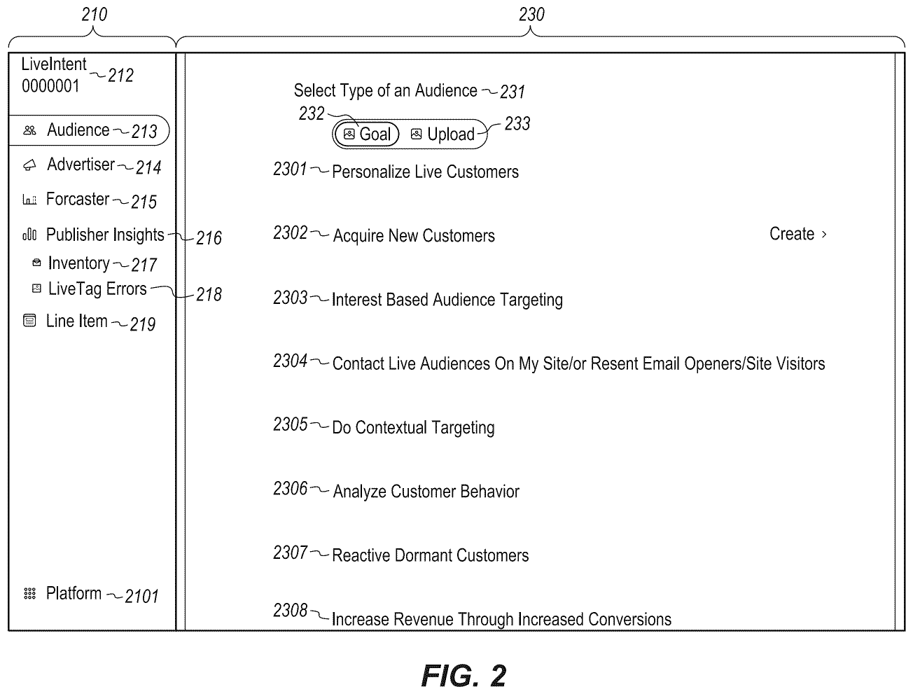

In order to come to this screen, all that advertisers will have to do is to tell us their goal of what they want to accomplish in our platform in screen 1 (FIG. 2) and we pregenerate the set of audiences based on the goals on active and prior campaigns through an “always on” feedback.

“Always on”: The goal of the UI is to take an advertiser to activating their audiences in preferably 3 simple steps: specify goal, pick precomputed tailored audiences, activate/launch a campaign. Now, once the advertiser launches a campaign, we use real time campaign performance, click and conversion signal to map back to which of the audiences chosen worked best for the advertiser.

Based on which of the audiences work best for the campaign, we may generate more of the specific kind of audiences tailored for the advertiser.

Preferably based on incremental learning machine learning models. We may look at the universal set of users through a singular focus lens. For example, if the composition of audiences launched in the campaign consists of New Site Visitors+Top Interest Group+Lookalikes+Predictive. We may start with 25% (or more or less) of audiences for each of them. We may adjust this composition based on real time campaign performance/feedback to say more of Predictive audiences, less of lookalikes, depending on the feedback. So for the next iteration the composition could vary as follows: New Site Visitors—28%; Predictive—35%; Lookalikes—17%; Top Interest Group—20%. Such composition preferably based on performance and/or feedback.

We may generate a fresh set of audiences, rank them and pick the top e.g. 28% for New Site Visitors and top e.g. 35% hashes for predictive etc. Then this composition goes through the next iteration and we preferably keep making such adjustments throughout the lifetime of the campaign. This may be from the perspective of a specific advertiser campaign based on a variety of heuristics.

In the above examples, heuristics may include creating audiences based on the behavior or interest data of site visitors (Contextual audiences), based on the highest probability of a user clicking or converting for an advertiser (Predictive audiences), based on users who are similar to current clickers/purchasers (lookalike) etc.

We may keep adding more heuristics as and when we add new types of audiences. Examples may include LIHP (high engagement clickers and converters across the exchange), simURL audiences (people who liked for example product A also liked another product B) etc., may offer as a preliminary data about them and their goals.

Preliminary data may include, but is not limited to: prior campaigns run with Liveintent; data collected from a website, e.g. through live connect tags or other tags; email service provider click logs; liveconnect email extension; identity graph attributes; offline graph attributes; propensity of individual hashes to engage with specific advertisers; Online browsing patterns of users on an aggregate basis; Customer lifetime value of a user for the advertiser, and other data.

This model may be an encompassing model that can incorporate click and conversion signals from a wide range of campaigns.

Campaigns may be line items that allow advertisers to show newsletter ads on a set of users. So to have separate models for exemplary heuristics like: a model for contextual audiences that takes advertiser attributes based on data points listed above as input but outputs score for each user for contextual relevance for the advertiser; a model for ranking users similar to current converters/clickers for the current advertiser but also takes advertiser attributes based on data points listed above as inputs.

Other models may run on top of this one, e.g. that takes a current day's (or longer or shorter time period) campaign performance as input and predicts the right audience composition to be active on the campaign for the next day. This model may predict that work on different types of audiences and strategy cards.

Overview of how the auction mechanism preferably works: Strategy cards are a combination of pricing types and optimization strategies. There may be two main pricing types that clients can choose to set up campaigns on: First price auction or second price auction. Optimization can be done for at least two events: clicks/conversions. Within conversions, clients can choose to prioritize conversions, prioritize the budget, prioritize achieving conversions within a specified cpa (cost per action) or prioritize achieving return on ad spend—all of which fall under optimizing to conversions category mentioned in the previous line.

For implementing the strategy card, we use Predict which is an optimization engine. Predict uses historical campaign performance, if any, and takes into account any of the attributes that the campaign or advertiser might have and runs an auction that allows bidders to bid based on the click probability and conversion probability of a user for a specific campaign. So bids on higher likelihood to conversion users may be higher than bids on the lower likelihood to convert.

We preferably dynamically adjust the audience composition of the users that go into the targeting for a campaign/a line item through the optimization engine based on performance of the current campaign and/or the users who convert through the campaign up until a certain point in time. Preferably combined with optimization functions that are used to create those audiences to help achieve the current campaign creator's end goal.

We preferably begin by periodically activating portions of the audience traffic in the campaign. This is the same as changing composition of different types of audiences based on campaign performance over a period of time.

We preferably obtain the hybrid audience from a wide variety of optimization functions including but not limited to models that generate an audience to optimize for more views, clicks, conversions, targeting based on interest behavior or ad page context. This data may come from, e.g.: Prior campaigns, e.g. campaigns run with Liveintent; Event data, add to cart data and conversion collected from a website through live connect or other tags; email service provider click logs; liveconnect email extension or other extension; identity graph attributes; offline graph attributes; propensity of individual hashes to engage with specific advertisers; Online browsing patterns of users on an aggregate basis; Sourced graph data attributes; Email subscription data; Newsletter opens and reopens, website visits, etc.

When a significant leap in campaign performance is achieved through any of these audiences for a specific optimization function, the model has the capability to incorporate the feedback signal and generate more audiences of the same or similar kind.

We may be an SSP for email newsletter ads—we may get the hashed email of users who clicked and converted on a campaign. We may trace back the users who clicked and converted on a campaign to which audience they originated from. In the previous paragraphs we referred to a model that will predict audience composition that will take the current campaign performance and the set of users who clicked and converted as input to predict this audience composition.

On a similar note, the model would inherently refrain from adding audiences that do not work for a particular campaign set up. This is related to altering the composition of audiences by checking which audience product is driving maximum clicks/conversions for the current advertiser and increasing or decreasing composition based on what works.

We may start this process from a variety of precomputed audiences for each specific advertiser. Some examples may include: Predictive audiences relevant to the current advertiser; Contextual audiences relevant to the current advertiser; Email engagement audiences; Site visitor audiences; and people who liked similar products.

Embodiments of the invention may include: A campaign feedback based incremental hybrid audience suggestion AI engine comprising: A first interface via which a user can input one or more goals, the goals including one or more of: personalizing live customers, acquiring new customers, interest based audience targeting, contacting live audience, contextual targeting, analyzing customer behavior, reactivating dormant customers, and increasing revenue through increased conversions; pregenerating a set of audiences based on the user input goals; allowing a user to select at least one of the pregenerated set of audiences; and allowing a user to launch a campaign.

Embodiments may include: where after a campaign is launched, real-time campaign performance is used, and click and conversion signals map back to the best performing audiences in the campaign; generating additional audiences based on audiences that work best with the campaign; where the engine uses at least one incremental learning machine learning model, facilitating looking at a universal set of users through a singular focus lens; adjustment of the composition of audiences based on real-time or other campaign performance or feedback; generating a new set of audiences, ranking them, and incorporating a portion of them; adjusting the engine based on one or more of: behavior or interest data of a site visitor, predictive probability of user action, and similarity of users to other users; additional heuristics including one or more of high engagement clickers and converters, and prior user relationships to other products.

Embodiments may include: preliminary data, including one or more of: prior campaigns, data collected from web sites through tags, email service provider click logs, email extensions, identity graph attributes, offline graph attributes, propensity of individual hashes to engage with specific advertisers, online browsing patterns of users on an aggregate basis, and customer lifetime value of a user for an advertiser; click and conversion signals from a plurality of campaigns; including multiple models for different heuristics, including one or more of: a model for contextual audiences based on advertiser attributes as inputs and outputs scores for users related to contextual relevance for an advertiser, and a model for ranking users similar to existing converters; including a model taking a days campaign performance as input and predicting audience composition to be active on the campaign for the next day; including an auction mechanism utilizing strategy cards that are a combination of pricing types and optimization strategies; including an optimization engine for implementing a strategy card, where the optimization engine uses historical campaign performance, takes into account campaign and/or advertiser attributes, and allows bidders to bid based on click probability and conversion probability of a user for a specific campaign; including dynamic adjustment of the audience composition of users that go into targeting for a campaign, including based on performance of a current campaign, or users who convert through a campaign; including periodically activating portions of the audience traffic in a campaign; where a hybrid audience is obtained from a variety of optimization functions including: models that generate an audience to optimize, and targeting based on interest behavior or ad page context; including incorporating feedback signals into models to generate more audiences of similar kind; where the engine refrains from adding audiences that do not work for a particular campaign setup; and potentially including using a variety of precomputed audiences for a specific advertiser, including one or more of: predictive audiences relevant to an advertiser, contextual audiences relevant to an advertiser, email engagement audiences, site visitor audiences, and people who liked similar products.

For a more complete understanding of various embodiments of the present invention, reference is now made to the following descriptions taken in connection with the accompanying drawings.

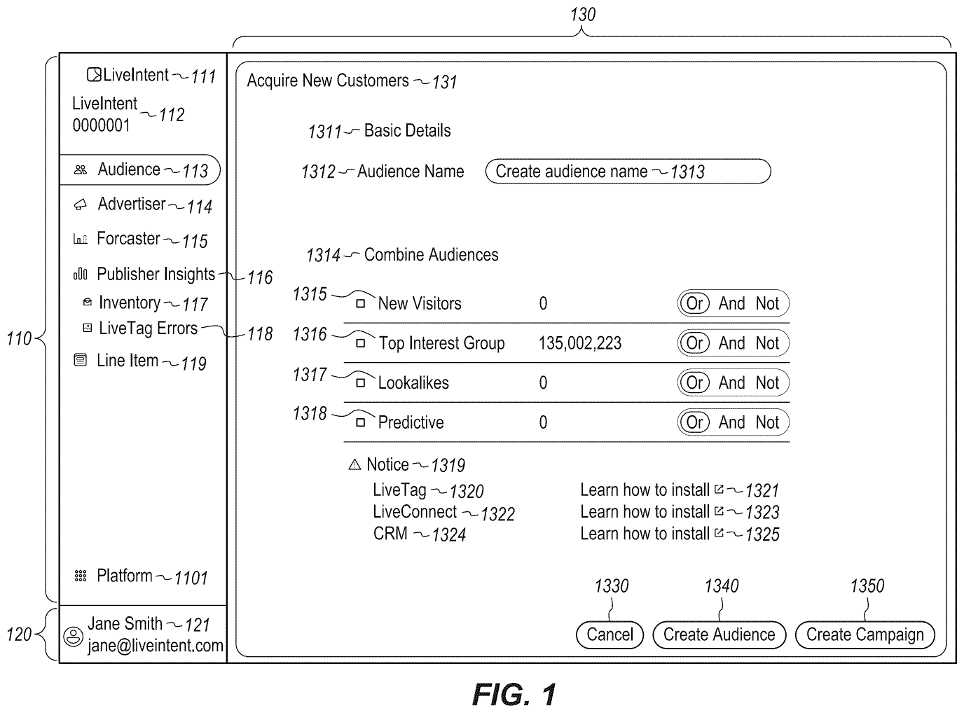

FIG. 1 illustrates an interface, here related to acquiring new customers. The interface of FIG. 1 includes menu section 110, user information 120, and interface selectors 130. As illustrated in FIG. 1, menu section 110 may include customer indicator 111, customer identifier 112, along with the following menu items: Audience 113 which is selected, Advertiser 114, Forecaster 115, Publisher Insights 116, Inventory 117, Errors 118, and Line Item 119. As illustrated in FIG. 1, menu section 110 also includes Platform item 1101.

FIG. 1 also illustrate user information 120, including account information 121, here a name and an email address.

Interface information 130 as illustrated includes Acquire New Customers interface 131, which as illustrated includes: Basic details 1311, Audience name 1312, and Create audience name button 1313. As illustrated, Acquire New Customers interface 131 also includes Combine Audiences section 1314, including New Visitors 1315, Top Interest Group 1316, Lookalikes 1317, and Predictive 1318, each of which as illustrated may include an Or/And/Not selector. Combined Audiences section 1314 as illustrated also includes warning information 1319. Warning information 1319 may contain information warning a user about selections, and is illustrated with indications of audiences that could not be generated, here: LiveTag 1320 along with learn how to install link 1321; LiveConnect 1322 along with learn how to install link 1323; and CRM 1324 along with learn how to install link 1325.

Acquire New Customers interface 131 as illustrated further includes the following action buttons at the bottom: Cancel 1330 to cancel the process; Created Audience 1340 to create the specified audience; and Create Campaign 1350 to create the specified campaign.

FIG. 2 illustrates an interface, here related to selecting audience type. The interface of FIG. 2 includes menu section 210 and interface selectors 230. As illustrated in FIG. 2, menu section 210 may include customer identifier 212, along with the following menu items: Audience 213 which is selected, Advertiser 214, Forecaster 215, Publisher Insights 216, Inventory 217, Errors 218, and Line Item 219. As illustrated in FIG. 2, menu section 210 also includes Platform item 2101.

Interface information 230 as illustrated includes Select Type of Audience interface 231, which as illustrated includes Goal 232 and Upload 233 capabilities. As illustrated, Select Type of Audience interface 231 includes the following options: Personalize Live Customers 2301 for personalizing existing live customers; Acquire New Customers 2302 for acquiring new customers; Interest Based Audience Targeting 2303 for targeting audiences on the basis of interests; Contact Live Audiences On My Site/or Resent Email Openers/Site Visitors 2304 for contacting live audiences on a site, resent email openers, and site visitors; Do Contextual Targeting 2305 for doing contextual targeting; Analyze Customer Behavior 2306 for analyzing customer behavior; Reactive Dorman Customers 2307 for dormant customers; and Increase Revenue Through Increased Conversions 2308 for increasing revenue through increased conversions.

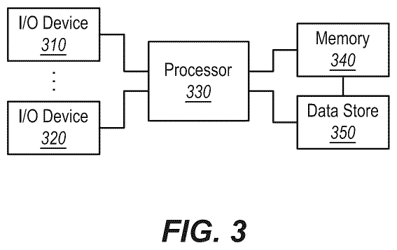

FIG. 3 illustrates exemplary potential system elements. As illustrated in FIG. 3, the system may include components including input/output device 310, input/output device 320, processor 330, memory 340, and data store 350.

As will be realized, the systems and methods disclosed herein are capable of other and different embodiments and its several details may be capable of modifications in various respects, all without departing from the invention. For example, specific implementation technology used may be different than those exemplified herein, but would function in a similar manor as described. Accordingly, the drawings and description are to be regarded as illustrative in nature and not in a restrictive or limiting sense.

Figures will be taken as nonlimiting.

1. A campaign feedback based incremental hybrid audience suggestion AI engine comprising:
A first interface via which a user can input one or more goals, the goals including one or more of: personalizing live customers, acquiring new customers, interest based audience targeting, contacting live audience, contextual targeting, analyzing customer behavior, reactivating dormant customers, and increasing revenue through increased conversions;
pregenerating a set of audiences based on the user input goals;
allowing a user to select at least one of the pregenerated set of audiences;
and allowing a user to launch a campaign.

2. The AI engine of claim 1, where after a campaign is launched, real-time campaign performance is used, and click and conversion signals map back to the best performing audiences in the campaign.

3. The AI engine of claim 1, including generating additional audiences based on audiences that work best with the campaign.

4. The AI engine of claim 1, where the engine uses at least one incremental learning machine learning model, facilitating looking at a universal set of users through a singular focus lens.

5. The AI engine of claim 1, including adjustment of the composition of audiences based on real-time or other campaign performance or feedback.

6. The AI engine of claim 1, including generating a new set of audiences, ranking them, and incorporating a portion of them.

7. The AI engine of claim 1, including adjusting the engine based on one or more of: behavior or interest data of a site visitor, predictive probability of user action, and similarity of users to other users.

8. The AI engine of claim 1, including additional heuristics including one or more of high engagement clickers and converters, and prior user relationships to other products.

9. The AI engine of claim 1, including preliminary data, including one or more of: prior campaigns, data collected from web sites through tags, email service provider click logs, email extensions, identity graph attributes, offline graph attributes, propensity of individual hashes to engage with specific advertisers, online browsing patterns of users on an aggregate basis, and customer lifetime value of a user for an advertiser.

10. The AI engine of claim 1, including click and conversion signals from a plurality of campaigns.

11. The AI engine of claim 1, including multiple models for different heuristics, including one or more of: a model for contextual audiences based on advertiser attributes as inputs and outputs scores for users related to contextual relevance for an advertiser, and a model for ranking users similar to existing converters.

12. The AI engine of claim 1, including a model taking a days campaign performance as input and predicting audience composition to be active on the campaign for the next day.

13. The AI engine of claim 1, including an auction mechanism utilizing strategy cards that are a combination of pricing types and optimization strategies.

14. The AI engine of claim 1, including an optimization engine for implementing a strategy card, where the optimization engine uses historical campaign performance, takes into account campaign and/or advertiser attributes, and allows bidders to bid based on click probability and conversion probability of a user for a specific campaign.

15. The AI engine of claim 1, including dynamic adjustment of the audience composition of users that go into targeting for a campaign, including based on performance of a current campaign, or users who convert through a campaign.

16. The AI engine of claim 1, including periodically activating portions of the audience traffic in a campaign.

17. The AI engine of claim 1, where a hybrid audience is obtained from a variety of optimization functions including: models that generate an audience to optimize, and targeting based on interest behavior or ad page context.

18. The AI engine of claim 1, including incorporating feedback signals into models to generate more audiences of similar kind.

19. The AI engine of claim 1, where the engine refrains from adding audiences that do not work for a particular campaign setup.

20. The AI engine of claim 1, including using a variety of precomputed audiences for a specific advertiser, including one or more of: predictive audiences relevant to an advertiser, contextual audiences relevant to an advertiser, email engagement audiences, site visitor audiences, and people who liked similar products.
